(19) United States
(12) Patent Application Publication
(10) Pub. No.: US 2007/0150254 A1
(43) Pub. Date: Jun. 28, 2007

(54) Simulation engine for a performance validation system

(76) Inventors: Cathy Y. Choi, Peterborough (GB); Stephen A. Faulkner, Lincolnshire (GB); William Kent Rutan, Chillicothe, IL (US); James Joseph Faletti, Spring Valley, IL (US); Eric C. Fluga, Dunlap, IL (US); Robert Michael McDavid, Peoria, IL (US); Donald B. Edwards, Peoria, IL (US); Mark D. Anderson, Dunlap, IL (US); Adam John Covell, Peterborough (GB)

Correspondence Address: CATERPILLAR/FINNEGAN, HENDERSON, L.L.P., 901 New York Avenue, NW, WASHINGTON, DC, 20001-4413, US

(21) Appl. No.: 11/589,813

(22) Filed: Oct. 31, 2006

Related U.S. Application Data
(60) Provisional application No. 60/752,915, filed on Dec. 23, 2005.

(51) Int. Cl. G06F 9/45

(52) U.S. Cl. 703/22

(57) ABSTRACT

A method of simulating performance characteristics of a product to be manufactured includes identifying a plurality of simulation modules each representative of one or more components of the product. The method also includes linking the plurality of simulation modules together to provide a model capable of generating an output associated with one or more performance characteristics of the product and running at least some of the simulation models in parallel to provide performance information related to the one or more performance characteristics of the product. The method can also include outputting the performance information.

### TECHNICAL FIELD

This application relates generally to computer simulation systems and methods, and more particularly to a simulation engine for a performance validation system.

### BACKGROUND

As technology progresses, machines continue to become increasingly complex. Similarly, the processes associated with designing and manufacturing these machines have become increasingly complex. At the same time, competition in the marketplace has encouraged new design and manufacturing techniques aimed at streamlining the overall manufacturing process. Reducing time and effort spent during the manufacturing process can significantly affect the overall efficiency, and therefore, the profitability associated with manufacturing a particular product or machine.

Computer aided design (CAD) is one technique that has emerged for improving overall manufacturing efficiency. CAD takes advantage of the computational power of today's microprocessors to provide product design engineers with a technique for generating a complete product design package without ever having to assemble a piece of hardware. For example, product components can be fully configured within the virtual environment. Moreover, mating components can be analyzed within the virtual environment to confirm that the configurations of each of the mating components provides the intended clearances.

Still, even in CAD-based manufacturing systems, once the product has been fully designed in the virtual space, the traditional method of validating the performance of the product is physical testing. That is, a prototype of the product design is built and subjected to various physical tests to observe its performance characteristics.

This prototyping and testing method, however, is slow and expensive. Not only can it take a significant amount of time to build the prototype (e.g., configuring suitable tooling, cutting metal, and assembling the components), but the resources expended (e.g., time and raw materials) to generate the prototype add cost to the manufacturing process.

Further, this prototyping and testing method lacks flexibility. For example, it may be difficult or impossible to assemble the prototype with the capability of interchanging one or more components. As a result, testing of more than one specific configuration of the design can be difficult. Thus, a product design and/or implementation team may be unable to assess the impact to product performance that may be provided by the substitution of one or more components in the particular design configuration. As a result, particular alternate product configurations that may provide enhanced performance characteristics may be overlooked and not incorporated into the final product design.

Further, in view of the difficulty and expense of building a prototype for testing, it may be difficult to justify the expense of building a prototype of the entire product or machine. To mitigate costs, a manufacturer may be inclined to build and test only a subsystem of the machine. Such an approach, however, does not provide the benefit of observing the operation of the entire machine, which may depend on the performance characteristics and, perhaps more importantly, on the interaction of the various components and systems of the overall product or machine configuration.

To further streamline the manufacturing processes for a machine, computer aided simulation (CAS) techniques have been proposed for validating certain performance characteristics of a machine design. These systems rely on the development of a computer simulation model to represent the operational characteristics of at least a part of the machine to be manufactured. By running a CAS associated with the machine, engineers can determine whether the designed product or machine will meet the intended performance goals once the machine has been manufactured.

One such CAS system is described in U.S. Patent Publication No. 2004/0107082 to Sato et al. (“the '082 publication”), which was published on Jun. 3, 2004. The '082 publication describes a car engineering assist system that uses a generic car simulation model to represent various aspects of a vehicle. A test module representing some characteristic or system of a test car design can be run with the generic car simulation model to provide a simulation result. Compiling these simulation results for the test car system and comparing the results to a compliant car system enables the operators of the CAS system to determine whether the test car system provides the intended performance characteristics.

While the system of the '082 publication can potentially decrease the time and cost required for validating the performance characteristics of a machine design, the system has several shortcomings. For example, the system relies upon the use of a master program to represent a particular car platform, and the performance validation simulation focuses on only one test module at a time. Specifically, the system of the '082 publication focuses on the performance characteristics of only a single test module representative of a selected system on the vehicle. The master program, i.e., the car simulation model, serves to provide only the platform-specific information that the test module may need to appropriately model the targeted vehicle system and its interaction with the overall vehicle platform. The master program does not include the capability to operate other test modules in parallel to simultaneously observe and validate the performance characteristics of a plurality of systems or components of the vehicle.

The presently disclosed systems and methods are directed to overcoming one or more of the problems set forth above.

### SUMMARY OF THE INVENTION

In accordance with one aspect, the present disclosure is directed toward a method of simulating performance characteristics of a product to be manufactured. The method includes identifying a plurality of simulation modules, each representative of one or more components of the product. The method also includes linking the plurality of simulation modules together to provide a model capable of generating an output associated with one or more performance characteristics of the product and running at least some of the simulation models in parallel to provide performance information related to the one or more performance characteristics of the product. The method can also include outputting the performance information.

According to another aspect, the present disclosure is directed toward a simulation engine. The simulation engine has a memory including instructions for identifying a plurality of simulation modules, each representative of one or more components of a product to be modeled. The memory also includes instructions for linking the plurality of simulation modules together to provide a model capable of generating an output associated with one or more performance characteristics of the product. Also included in the memory are instructions for running at least some of the simulation modules in parallel to generate performance information related to the one or more performance characteristics of the product and instructions for outputting the performance information. The simulation engine includes a processor configured to execute the instructions included in the memory.

In accordance with yet another aspect, the present disclosure includes a simulation system including at least one input device configured to receive input data from one or more users of the simulation system. A processor may be configured to run a simulation engine, the simulation engine being configured to build a simulation model by assembling a plurality of simulation modules and run at least some of the plurality of simulation modules in parallel. The simulation engine can compile an output based on the operation of the at least some of the plurality of simulation modules. Also included in the simulation system is a display configured to convey the output to the one or more users of the simulation system.

### BRIEF DESCRIPTION OF THE DRAWINGS

FIG. 1 provides a block diagram representation of a simulation system according to an exemplary disclosed embodiment; and

FIG. 2 provides a diagrammatic representation of a modeling environment according to an exemplary disclosed embodiment.

### DETAILED DESCRIPTION

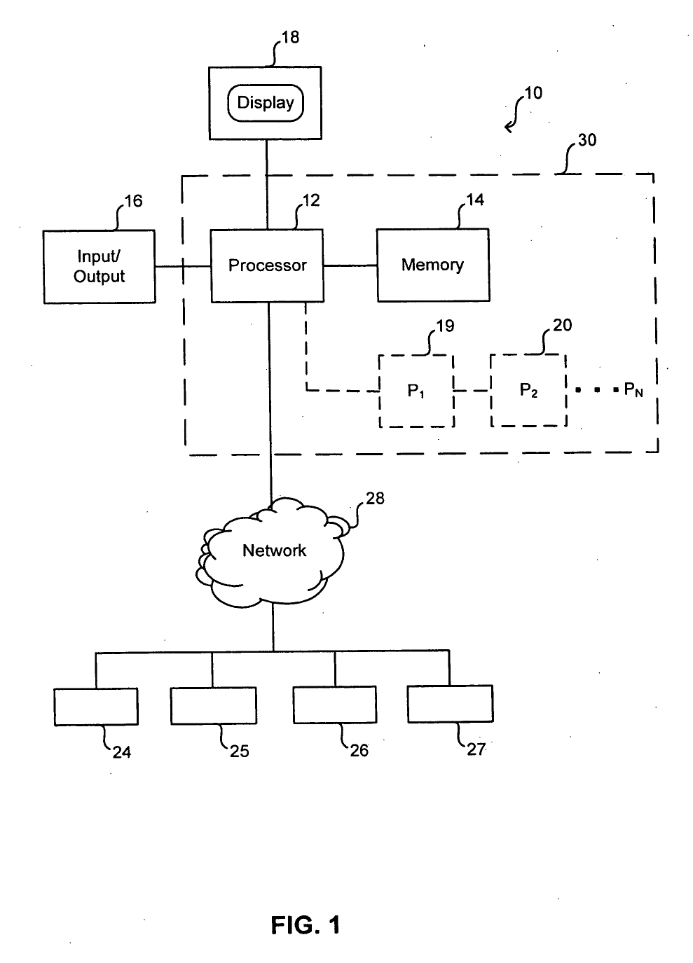

FIG. 1 provides a block diagram representation of a simulation system 10 according to an exemplary disclosed embodiment. Simulation system 10 may include a processor 12, a memory 14, at least one input/output device 16, and a display 18. Optionally, simulation system 10 may also include one or more additional processors 19, 20 (designated as processors P₁, P₂ . . . Pₙ). Simulation system 10 may also include one or more user workstations 24, 25, 26, 27 in communication with processor 12 via, for example, a network 28.

Memory 14 may include any type of storage media suitable for storing data and/or machine instructions. For example, memory 14 may include a hard disk, RAM, ROM, optical disks (e.g., CD-ROM disks, DVDs, etc.), flash memory, etc.

Together, memory 14 and processor 12 may constitute a simulation engine 30 configured to model various aspects of a product to be manufactured. In one embodiment, simulation engine 30 may be configured to receive data and/or information representative of a particular configuration of the product to be manufactured. Using this data and/or information, simulation engine 30 may build and run a model simulating the operation of the particular product configuration. Based on this simulation, simulation engine 30 can generate performance data relating to the simulated operation of the product, and this performance data can be compared to expected values to determine whether the specific product configuration exhibits a desired set of performance characteristics. Thus, simulation engine 30 can effectively operate as a performance validation system to predict whether a particular product configuration will perform at or above minimum design thresholds.

In order to validate the performance of a particular product configuration, simulation engine 30 may be configured to model one or more elements of the product. Simulation engine 30 may be used to model any type of product to be manufactured, but in certain embodiments, simulation engine 30 may generate a model for a work machine. Such work machines, for example, may include trucks, wheel loaders, skid steers, generators, boats, on-highway vehicles, off-highway vehicles, engines, compactors, tractors, excavators, forest use equipment, motor graders, tools, etc.

Work machines may include a complex assembly of parts, components, and systems. For example, a work machine, such as a truck, may include thousands of individual parts (e.g., bolts, housings, pistons, cams, injector nozzles, turbine blades, etc.) These parts may be assembled together to provide various components of the work machine (e.g., fuel injectors, hydraulic cylinders, transmissions, generators, particulate traps, electronic control units, turbochargers, etc.). Further, the components may be assembled together to create various systems of the work machine (e.g., engine, fuel, air, drivetrain, hydraulics, cooling, and exhaust systems, etc.).

Simulation engine 30 can generate a virtual machine by assembling together various simulation modules designed to represent these parts, components, and/or systems. In certain embodiments, the virtual machine may be represented solely by simulation modules at the system level. In other situations, one or more simulation modules representative of various components of a system may be incorporated into the virtual machine model. Further still, and to provide even more granularity to the virtual machine model, simulation modules of individual parts included within the components of a system may be incorporated into the virtual machine model.

Because a machine, ultimately, may include a compilation of systems, components, and parts, the overall performance of the machine may be affected by the operational and functional characteristics associated with any of the systems, components, and/or parts of the machine. Especially on the component and system levels, the performance of many of the components and systems may be interrelated such that the operational and functional characteristics of one or more systems or components may directly impact the operation and functional characteristics of other systems and components. On the most basic level, the physical characteristics of even one part in one particular system may have an effect on the operation of the entire machine.

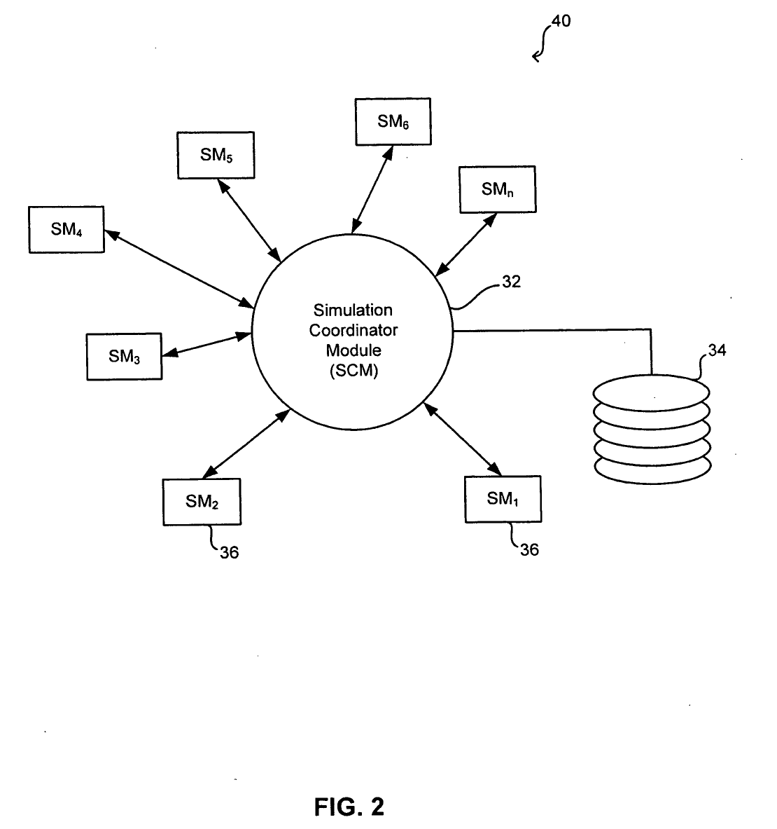

To provide an performance validation model of a product to be manufactured, such as a work machine, simulation engine 30 may provide a modeling environment 40, as diagrammatically represented by FIG. 2. Modeling environment 40 may include a simulation coordinator module (SCM) 32 in communication with a plurality of simulation modules 36, which are designated as SM₁ to SMₙ. Modeling environment 40 may also include a repository for storage of simulation modules 36, such as a database 34, for example.

Each of the plurality of simulation modules 36 may be configured to model the operational behavior of at least one of a part, component, or system of a product to be manufactured. One task of SCM 32 may include selecting and assembling various simulation modules 36 to generate a performance model of the product to be manufactured. This model can represent the operational characteristics of just a few parts of the product, one or more components included in the product, or one or more systems of the product. In certain embodiments, the model may represent a complete machine with all systems and components accounted for in the simulation model.

Simulation modules 36 may be generated by various entities. For example, in one embodiment, a manufacturer of the product may generate the plurality of simulation modules 36 by preparing simulation code representative of the performance behavior of one or more parts, components, or systems of the product. Alternatively, an entity other than the manufacturer of the product (e.g., a part or component manufacturer different from the product manufacturer) can provide the simulation modules 36. In still other embodiments, the simulation modules 36 may be provided by both the manufacturer of the product and various component or part manufacturers. Any of the plurality of simulation modules 36, regardless of origin, may be stored in database 34 for access by SCM 32.

The product manufacturer may even solicit the submission of simulation modules from various part or component manufacturers for purposes of evaluating the overall effect the parts or components provided by those manufacturers may have on the performance of the product to be manufactured. As an illustrative example, the product manufacturer may be interested in evaluating the performance of several configurations of a track type tractor each including a different model of particulate trap. Rather than generating a simulation module for each of the particular trap models in which the product manufacturer is interested, the product manufacture may, instead, rely upon the various particulate trap manufacturers to provide suitable simulation models representative of their respective traps.

Then, the product manufacturer, using SCM 32, for example, could link into the product performance simulation model each of the particulate trap simulation modules, one at a time, and evaluate the expected performance of the tractor for each one of the modeled particulate traps. For example, the predicted emission levels of particulates from the tractor could be monitored to determine whether predetermined emissions goals will be met by an exhaust system of the tractor that included the prospective particulate trap. Moreover, the overall performance of the product to be manufactured could be evaluated to determine whether any positive or negative effects on one or more other systems or components of the tractor would result from the incorporation of the selected particular trap. While the example above has been described with respect to the evaluation of candidate particulate traps for incorporation into a track type tractor, it should be noted that simulation modules representative of any parts, components, or systems of any type of machine or product may be assembled together in modeling environment 40 for purposes of evaluating the performance characteristics of the overall product or any part, component, or system associated with the product.

Simulation modules 36 may include any suitable types of CAS modeling techniques. In one embodiment, one or more of the plurality of simulation modules 36 may include a predictive type model. This type of model may operate as a “black box” designed to provide a set of output values based on a set of variable input values. Rather than simulating the actual physical processes occurring within a system, component, or part, these predictive models may be built upon empirical data and configured to mimic an observed set of response characteristics. That is, through bench testing, for example, an array of input values may be provided to a system, and the response of the system can be measured and documented. Using this information, a predictive model can be generated to mimic the performance of the actual system. When supplied with a particular set of input values, for example, the predictive model may return one or more output values similar to those produced by the actual system under the same input conditions.

Alternatively, one or more of the plurality of simulation modules 36 may include a physical simulation routine configured to model the actual physical behavior of a part, component, or system of the product to be manufactured. For example, rather than simply predicting a performance response based on observed behavior, as in a predictive simulation model, the physical simulation model may be configured to actually “understand” the physical processes occurring within or associated with a part/component/system. Thus, for a set of input conditions, the physical simulation model may run a simulation of one or more physical processes and calculate output values that would result from the input conditions. In some embodiments, the calculated output may change or provide the input conditions for a subsequent iteration of the physical simulation model.

As an illustrative example, a simulation module from among the plurality of simulation modules 36 may be configured to run a physical simulation of the combustion processes occurring in a particular cylinder of an engine. The physical simulation model in this example may be capable of calculating various characteristics associated with the combustion process (e.g., pressure in cylinder, temperature, time of burn, etc.) based on various input information (e.g., cylinder dimensions, fuel injection pressure and type, fuel plume shape, temperature in cylinder, etc.). This physical simulation model can run continuously and provide continuous output data that may be used by yet another simulation module operating under the control of SCM 32 in modeling environment 40.

Compared to predictive type models, physical simulation models may be more computationally intensive and, therefore, may require more processing resources. On the other hand, physical simulation models may provide increased accuracy and may be more flexible than predictive models. For example, each time there is a configuration change of a part/component/system to be modeled by a predictive system, bench testing of a prototype having the new configuration may be needed to generate the empirical data on which the predictive model is based. In contrast, a physical simulation model may be designed to base its calculations not on empirically determined data, but on the particular values associated with a general set of parameters (e.g., cylinder diameter, cylinder volume, fuel pressure, etc.) associated with each product configuration. Thus, a physical simulation model may be capable of modeling the performance characteristics of a new product configuration simply by reading in the particular parameter values that define the new configuration.

SCM 32 can build a unique performance simulation model within modeling environment 40 for each particular configuration of the product to be manufactured. To build the simulation model, SCM 32 may access database 34 and select a plurality of simulation modules 36 that together represent one or more components or systems of the product to be manufactured. SCM 32 assembles, or links, the selected plurality of simulation modules 36 together to provide the performance simulation model. For purposes of this disclosure, the terms linking and assembling are used interchangeably and refer to the establishment of any type of communication path between/among any two or more of the plurality of simulation modules 36 and/or between SCM 32 and any of the plurality of simulation modules 36.

SCM 32 may select an appropriate set of simulation modules 36 for assembly based, for example, on user input defining a particular product configuration. A user of simulation system 10 may interface with simulation engine 30 via input/output device 16 and provide a specification defining the product to be manufactured. Such a specification can also be provided to processor 12, for example, by any of user workstations 24-27 across network 28. This specification may define any number of components and/or systems of the product, and, as previously mentioned, SCM 32 may select and assemble together the plurality of simulation modules 36 based on this specification.

Alternatively, instead of providing a specification, a user may simply provide instructions for selecting certain simulation modules to SCM 32 via input/output device 16 or any of user workstations 24-27. In this case, SCM 32 may merely interpret the input instructions provided by the user to select and assemble appropriate simulation modules 36.

SCM 32 may be configured to communicate with the plurality of simulation modules 36 via a standardized interface. For example, a standardized information transfer protocol may be defined such that SCM 32 can interpret information provided to it by any of simulation modules 36. This standardized information transfer protocol may include, for example, the use of data headers that explain the size, quantity, and type of data included in subsequent data fields supplied to SCM 32. Of course, any known protocol for providing information to SCM 32 in a standardized, recognizable format may be used.

Configuring SCM 32 and simulation modules 36 with a standardized interface can provide flexibility to simulation system 10. For example, various entities can develop simulation modules, and as long as these simulation modules are configured to transfer data according to a standardized data transfer protocol, they can be made available for assembly via SCM 32 without any special reconfiguration of the modeling system. The use of such a standardized interface provides, essentially, a plug and play performance simulation modeling system.

Once a performance simulation model is assembled, including a plurality of simulation modules 36, SCM 32 may run at least some of the plurality of simulation modules 36 in response, for example, to a command provided by a user of simulation system 10. SCM 32 may be configured to coordinate the operation of the simulation modules 36 in a parallel fashion. Particularly, SCM 32 can initiate the simultaneous operation of multiple simulation modules such that each generates simultaneous output information relating to the performance characteristics of the part, component, or system modeled by the particular simulation module.

In addition to initiating and coordinating the parallel operation of multiple simulation modules 36, SCM 32 can also enable the sharing of information among the plurality of simulation modules 36. For example, during operation, data generated by one simulation module relating to the operational or performance characteristics of a particular part/component/system of the product to be manufactured can be made available to other simulation modules operating in parallel. In this way, the operational status of one part/component/system of the product can be accounted for in the simulated operation of another part/component/system of the product provided by another simulation module.

SCM 32 may operate on a single processor 12. Alternatively, SCM 32 may be configured to spawn out processes associated with the operation of the plurality of simulation modules 36 onto one or more additional processors such as processors 19, 20, etc.

During operation, SCM 32 may be configured to provide output information relating to the operation of one or more of the plurality of simulation modules 36. This output information may include performance characteristics associated with the product to be manufactured. Particularly, the output information may include performance characteristics associated with certain parts/systems/components of the product or, alternatively or additionally, the product as a whole.

This output information may be conveyed to a user of simulation system 10 on display 16 or on a display associated with any of user workstations 24-27. Alternatively or additionally, the output information may be included in a report generated by SCM 32 during operation of the plurality of simulation modules 36. Both updates to the information provided to display 16 (or other displays associated with simulation system 10) and/or included in a generated report can be made in real time (e.g., at the clock frequency or some multiple of the clock frequency of processor 12 or any other suitable timing device). Updating the information in this manner may enable a user to examine the performance characteristics of the product to be modeled over a continuous period of time.

The output provided by SCM 32 ultimately may be related to a set of input parameters supplied by a user of simulation system 10. Particularly, a user may supply a general set of input conditions representative of a broad range of expected operating conditions for the product to be manufactured. These operating conditions, for example, may represent the conditions in which the product is expected to operate for a predetermined percentage of time (e.g., 80%). The performance data generated by SCM 32 and the plurality of simulation modules, based on this general set of input conditions, can help a user validate the performance of a particular product configuration with respect to the range of expected operating conditions that the product is most likely to encounter.

Alternatively, a more focused set of input conditions can be supplied to SCM 32. For example, input conditions relating to a particular work site where a particular product may be destined for operation may be supplied to SCM 32. Using these input conditions, a user of simulation system 10 may validate whether the performance of a particular product configuration will be sufficient not for a general set of conditions, but for the specific conditions associated with the particular worksite.

As an illustrative example, the input conditions supplied to SCM 32 and simulation modules 36 may include specific data such as, for example, the intended duty cycle for a particular machine or category of machines (e.g., the frequency and duration that a machine will be operated); climate data where the machine will be operated; specific terrain maps (e.g., GPS data) of a particular worksite; and any other applicable data that may affect the performance of the product to be manufactured.

Simulation system 10 can indicate to a user whether certain performance goals for a product to be manufactured have been met. These goals may be associated, for example, with emissions levels, power output, response time, cooling system performance, and/or any other performance characteristics of the product. In a case where the input conditions to SCM 32 are associated with a particular worksite for the product, simulation system 10 may aid a user in determining whether a particular product configuration would be suitable for operation at the worksite. For example, simulation system 10 may help a user determine whether a particular track system would provide adequate traction in muddy or sandy conditions present at the particular worksite; whether a particular product configuration would comfortably scale a particular incline known to exist at the worksite; whether the product configuration would meet the emissions requirement of a particular location; whether a particularly cold climate at the work site would adversely affect the performance of the particular product configuration, and any other similar considerations.

Because simulation system 10 may be configured to simulate the operation of various configurations of a product, simulation system engine 30 may be configured to run one or more optimization routines to aid in selection of a preferred configuration based on some predetermined selection criteria. For example, simulation system 10 may run simulations for a plurality of different product configurations. For each configuration, performance data potentially relating to multiple performance characteristics may be stored for later use by the optimization routine. Specifically, the optimization routine may examine the performance characteristics of a plurality of product configurations, subject these performance characteristics to a cost function representing a desired set of selection criteria, and minimize the cost function to determine which product configuration best satisfies the selection criteria. Any suitable optimization routine may be used to evaluate the performance characteristics of the plurality of product configurations.

### INDUSTRIAL APPLICABILITY

The disclosed simulation system may be used to model the operational behavior of various configurations of any type of product or machine to be manufactured. The disclosed simulation system, for example, can aid in the performance validation of a particular machine configuration by allowing a user or user group to determine whether performance requirements or targets will be met by the particular machine configuration.

This performance validation process can be a valuable step in the overall manufacturing process. For example, the performance validation step be performed for various different configurations of the product to determine which configuration may exhibit the best performance characteristics or the most suitable balance between performance and cost. Further, by employing computer aided simulation techniques, the performance characteristics of many different product configurations can be observed without ever committing resources to building the machine or, in some cases, even a prototype of the machine.

The standardized communication interface for transferring information and data between SCM 32 and the plurality of simulation modules 36 can add significant flexibility to simulation system 10. Specifically, the standardized interface can accept and run simulation modules from various different entities as long as these simulation modules are preconfigured to successfully communicate with SCM 32 and, therefore, effectively operate within simulation system 10. In other words, this standardized interface provides simulation system 10 with a plug and play quality. This plug and play quality may allow for swapping, adding, and/or substituting of simulation modules representative of various parts of a machine to determine what effects these changes would have on the machine performance or the performance of one or more systems of the machine.

Further, simulation system 10 may be used not just to validate the performance of a particular product configuration with respect to a general set of expected operating conditions, but may also be used to validate the performance of the product configuration with respect to any specific set of input conditions. This capability can translate into more accurate performance validation by focusing, for example, on the specific intended use of a particular machine. For example, if a particular machine was intended to be provided to a customer in Sweden where the average daily temperate was below freezing, and the customer intended to use the machine only for a two hour period, three times per year, these details could be supplied as input to simulation system 10. As output, simulation system 10 could provide validation of whether the machine would perform as desired under these specific conditions.

Another important feature of simulation system 10 is its ability to run multiple simulation modules simultaneously. By simulating the operation of many, if not all, of the systems of a machine together through parallel processing, each simulation module will be able to take advantage of operational characteristic information dynamically generated by any of the other simulation modules 36 being run by SCM 32. Sharing information among the simulation modules in this way can more closely model the actual performance characteristics of the product to be manufactured.

It will be apparent to those skilled in the art that various modifications and variations can be made to the disclosed simulation system without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method of simulating performance characteristics of a product to be manufactured, comprising:
identifying a plurality of simulation modules each representative of one or more components of the product;
linking the plurality of simulation modules together to provide a model capable of generating an output associated with one or more performance characteristics of the product;
running at least some of the simulation models in parallel to provide performance information related to the one or more performance characteristics of the product; and
outputting the performance information.

2. The method of claim 1, wherein outputting the performance information includes providing the information to a display.

3. The method of claim 1, wherein outputting the performance information includes generating a report.

4. The method of claim 1, wherein identifying the plurality of simulation models is performed by a processor in response to user input related to a configuration of the product.

5. The method of claim 4, wherein the user input is related to one or more components included in the product.

6. The method of claim 4, wherein the user input is related to one or more systems included in the product.

7. The method of claim 1, wherein the product is a work machine.

8. The method of claim 1, wherein linking includes establishing a communication path between a simulation coordinator module and the plurality of simulation modules via a standardized interface.

9. The method of claim 1 further including receiving input data representative of an expected working environment of the product, and wherein running at least some of the simulation modules includes providing the input data to the at least some of the simulation modules.

10. The method of claim 1, wherein running at least some of the simulation modules in parallel includes sharing of operational data among the at least some of the simulation models.

11. The method of claim 1, wherein each of the plurality of simulation modules is configured to model operational behavior of at least one of a part, component, or system of the product to be manufactured.

12. A simulation engine, comprising:
a memory including:
instructions for identifying a plurality of simulation modules each representative of one or more components of a product to be modeled;
instructions for linking the plurality of simulation modules together to provide a model capable of generating an output associated with one or more performance characteristics of the product;
instructions for running at least some of the simulation modules in parallel to generate performance information related to the one or more performance characteristics of the product; and
instructions for outputting the performance information; and
a processor configured to execute the instructions included in the memory.

13. The simulation engine of claim 12, further including a standardized interface for communicating with the plurality of simulation modules.

14. The simulation engine of claim 13, wherein the standardized interface is configured to enable sharing of operation data among the plurality of simulation models.

15. The simulation engine of claim 12, wherein outputting the performance information includes one or more of providing the performance information to a display or generating a report based on the performance information.

16. The simulation engine of claim 12, wherein the memory further includes at least one optimization routine for identifying a preferred product configuration, from among a stored list of product configurations, based on selection criteria.

17. The simulation engine of claim 12, further including an input device configured to receive user input related to a configuration of the product, and wherein identifying the plurality of simulation models is based on the user input.

18. The simulation engine of claim 12, further including an input device configured to receive data representative of an expected working environment of the product, and wherein running at least some of the simulation modules in parallel includes providing the data to the at least some of the simulation modules.

19. The simulation engine of claim 12, wherein each of the plurality of simulation modules is configured to model operational behavior of at least one of a part, component, or system of the product to be manufactured.

20. A simulation system, comprising:
at least one input device configured to receive input data from one or more users of the simulation system;
a processor configured to run a simulation coordinator module, the simulation coordinator module being configured to:
build a simulation model by assembling a plurality of simulation modules;
run at least some of the plurality of simulation modules in parallel; and
compile an output based on the operation of the at least some of the plurality of simulation modules; and
a display configured to convey the output to the one or more users of the simulation system.

21. The simulation system of claim 20, wherein the simulation coordinator module is further configured to share operational data among the at least some of the plurality of simulation modules.

22. The simulation system of claim 20, wherein the simulation coordinator module is further configured to communicate with the plurality of simulation modules via a standardized interface.

23. The simulation system of claim 20, wherein the simulation coordinator module together with the at least some of the plurality of simulation modules are configured to generate performance characteristics of a product to be modeled based on the input data, which is representative of operating conditions associated with a product to be modeled, provided by the one or more users.

24. The simulation system of claim 20, wherein the simulation coordinator module is configured to identify the plurality of simulation modules for assembly based the input data, which is representative of a configuration of a product to be modeled, provided by the one or more users.

25. The simulation system of claim 20, wherein the at least one input device and the processor are in communication over a network.

26. The simulation system of claim 20, wherein the simulation coordinator module is further configured to spawn off, to at least one other processor, one or more processes related to the running of the at least some of the simulation modules.

27. A computer readable medium including:
instructions for identifying a plurality of simulation modules each representative of one or more components of a product to be modeled;
instructions for linking the plurality of simulation modules together to provide a model capable of generating an output associated with one or more performance characteristics of the product;
instructions for running at least some of the simulation modules in parallel to generate performance information related to the one or more performance characteristics of the product; and
instructions for outputting the performance information.
